(19) United States
(12) Patent Application Publication
(10) Pub. No.: US 2002/0019817 A1
(43) Pub. Date: Feb. 14, 2002

(54) Method and system for trading in personal information and storage medium therefor

(75) Inventors: Aya Matsui, Fujisawa-city (JP); Akihiro Ogura, Yamato-shi (JP); Shigeru Yuzawa, Tokyo (JP)

Correspondence Address: Gerald R. Woods, IBM Corporation T81/503, PO Box 12195, Research Triangle Park, NC, 27709, US

(73) Assignee: International Business Machiness Corporation, Armonk, NY

(21) Appl. No.: 09/907,851

(22) Filed: Jul. 17, 2001

(30) Foreign Application Priority Data
Aug. 8, 2000 (JP) 2000-239953

(51) Int. Cl. G06F 17/30

(52) U.S. Cl. 707/1

(57) ABSTRACT

A method and system for trading personal information under conditions which allow the Internet users (ISP users) who own the information to participate. A user who receives a connection service via an Internet service provider (ISP) provides his/her personal information to the ISP with each item being classified as either public or secret. The ISP builds a database 6 for storage of the users' personal information and offers the information to requesting business entities in exchange for compensation. A portion of the compensation is returned to the users, for example, as a discount in the connection service charge.

### FIELD OF THE INVENTION

The present invention relates to a method and system for trading in personal information, and more particularly to a technique for providing an environment wherein personal information can be traded under the control of an individual (Internet user) to whom the personal information belongs for the convenience of enterprises or companies that wish to utilize personal information and individuals who obtain money in compensation for providing the personal information.

### BACKGROUND ART

The Internet has been widely used by not only companies but also general consumers due to the advancement in network technologies, and functional improvements and price reduction in information apparatuses.

The Internet may be defined as communications between computer systems specified by IP (Internet Protocol) addresses. However, it is typical for general users to connect to the Internet through an Internet service provider (ISP) providing Internet connection services, rather than obtaining IP addresses. A connection to an Internet service provider from a general user may be made by connecting to an access point of the ISP via a telephone line, using PPP (Point to Point Protocol). Subsequently, the user is able to browse the WWW (World Wide Web) via the ISP, to obtain data of any kind, to do online shopping, etc. A connection to an ISP from a general user is usually provided at a cost to the user. The ISP receives payment for the connection service typically either for a monthly fixed fee or for a variable fee based on connection time.

For companies that conduct or plan to conduct electronic commerce, personal information of users who access the Internet is important marketing information. They try to obtain personal information on their web pages by prompting a visitor (Internet user) to enter information such as his/her name, home address, and e-mail address.

However, there is a limit to the usefulness of the above described personal information collecting procedure. That is, an Internet user (general user) would have to enter the same information repeatedly each time the user browse a web page of a different company. Some users get tired of entering the personal information, and may inadvertently or even deliberately enter incorrect information. Further, a user may choose not to enter any data at all. This does not satisfy company's need for collecting reliable personal information.

Further, if a company collects personal information from its own web page, only a limited number of visitors can be accommodated, and this in turn limits the amount of data the company can expect to collect. Most companies, therefore, actively seek the establishment of an environment wherein the maximum amount of personal information can be acquired. But on the other hand, many ISP users may wish not to enter data each time they browse a different web page.

Some users may not mind disclosing or releasing their personal information so long as they can do it at their discretion or they can control the scope of disclosure. For these users, a certain system may be required whereby they would obtain some benefit in exchange for the disclosure of their personal information.

### SUMMARY OF THE INVENTION

An overview of the present invention will now be described. According to the present invention, a user who acquires an Internet connection service from an Internet service provider (ISP) provides his/her personal information to the ISP with each item thereof such as name, address, age, e-mail address, etc. being specified as either public or secret. The ISP then builds a database containing the personal information provided by the user and offers, for a fee, to provide business entities or companies only personal information item or items specified as public by the user. A portion of the proceeds obtained from the companies is preferably returned to the user in the form, for example, of a reduction in the user's connection service charge.

The present invention provides such an ISP system and ISP trading method so that a user may enter data only once to receive services from companies. As a further incentive, a user can get a reduction in ISP service fees in exchange for providing personal information. In addition, a return to a user may alternatively be effected by giving electronic “money”, various service coupons, service points, or the like. Furthermore, since the personal information may be disclosed only to companies chosen by the ISP, a user can disclose his/her personal information without anxiety.

On the other hand, a company purchases personal information from the ISP so that it does not have to expend its labor in collecting the personal information. Also, the company can easily acquire a great amount of personal information because the number of users using the ISP is generally large. Furthermore, reliability of personal information registered in the ISP is believed to be high because they are information on individuals (users) who have entered into a connection service contract with the ISP. Therefore, companies can obtain reliable personal information without any effort on their part.

For the ISP, the charge may be lowered because the ISP may expect to receive compensation from companies who receive the personal information. This may lead to the acquisition of more users. An increase in the number of users is also advantageous to the companies because the ISP may be accessed more times and the electronic commerce through the ISP may, therefore, be facilitated.

Thus, the present invention provides a trading system and method advantageous to all of the users, ISPs and companies. It is also possible to increase returns to the users by collecting information offering charges each time personal information is provided to a company, or each time the personal information is used by the ISP in favor of the company.

Personal information may be used in a form in which a company is provided with personal information which has been matched in a search operation by the company and specified as public or disclosable. Alternatively, the ISP may sort the personal information into categories, and provide personal information in a specified category. Furthermore, personal information may be used in a manner in which the ISP sends an e-mail message with an advertisement for a company to a proprietor of extracted (selected) information. The ISP may be required to report to the company after the delivery of e-mail.

The personal information may include data that the ISP can acquire, such as frequency in use of the ISP, online shopping through the ISP, and so forth. As a matter of course, such information items that a user has not entered have to be determined by the user whether or not they can be disclosed so that the personal information is handled under the control of the user. The personal information may also include knowledge information that is obtained through estimation, using the knowledge management method, from the data got hold of by the ISP and data stored in the database of the ISP. This knowledge information is also under the control of the user.

The ISP may periodically obtain personal information from the same user so that the latest personal information is always stored in the database.

### BRIEF DESCRIPTION OF THE DRAWINGS

FIG. 1 is a diagram showing an overview of a personal information trading system according to one embodiment of the present invention.

FIG. 2 is a diagram showing an illustrative data structure for information stored in a database.

FIG. 3 is a flowchart showing an illustrative trading method according to one embodiment of the present invention.

FIG. 4 is a diagram showing an illustrative registration setting screen.

FIG. 5 shows illustrative information items entered on the registration setting screen.

FIG. 6 is a flowchart showing an illustrative search operation performed by a company.

FIG. 7 shows an illustrative search display screen.

FIG. 8 shows an illustrative category designation screen.

### PREFERRED EMBODIMENTS

The preferred embodiments of the present invention will now be described in detail. It should be noted, however, that the present invention can be implemented in many different forms, and is not limited to such embodiments. In the embodiments described below, the same reference numerals are used throughout to denote corresponding or identical components.

In the following, mainly a method and system will be described; however, as will be apparent to one having the ordinary skill in the art, the present invention may also be carried out as a computer-readable program storage medium. Therefore, the present invention can be implemented by hardware, software or a combination of hardware and software. The program storage medium may be any computer-readable medium, such as a hard disk, a CD-ROM, an optical storage device, a magneto optical device, or the like.

A conventional computer system may be employed for the trading method and system according to the following embodiments. The computer system may include a central processing unit (CPU), a main memory (RAM) and a nonvolatile memory (ROM), which are interconnected by a bus. In addition, a coprocessor, a graphic accelerator, a cache memory and an input/output (I/O) controller may also be connected to the bus. An external storage device, a data input device, a display device, a communication controller and/or other devices may be connected to the bus via appropriate interfaces. Any hardware resource, generally provided in conventional computer systems, may be included. A typical external storage device is a hard disk drive, but a magneto-optical storage device, an optical storage device, or a semiconductor storage device such as a flash memory may also be used. An input device such as a keyboard, a pointing device such as a mouse, an image reader such as a scanner, an audio input device, and/or other device may be used as the data input device. The display device may be a CRT, a liquid crystal display device or a plasma display device. The computer system may be a personal computer, a workstation, a main frame or any other computer.

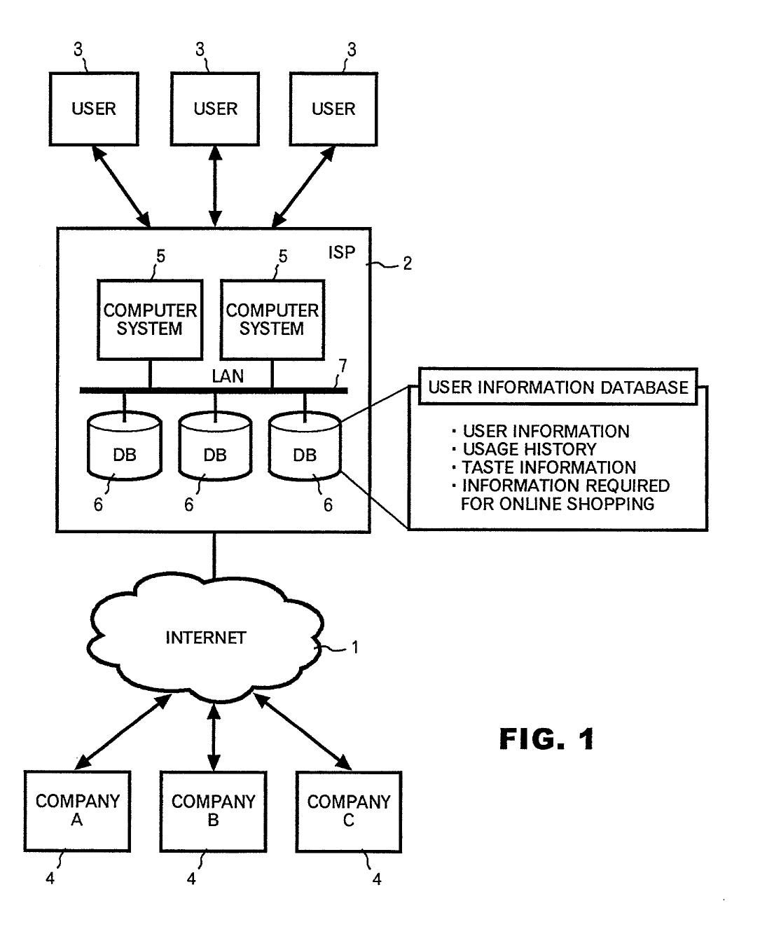

FIG. 1 shows an overview of a system for trading in personal information according to the preferred embodiment. This trading system comprises the Internet 1, an Internet service provider (ISP) 2, users 3, and companies 4.

As is well known in the art, the Internet 1 is a worldwide network connected by TCP/IP (Transmission Control Protocol/Internet Protocol) or UDP (User Datagram Protocol).

The ISP 2 is a business entity that provides Internet connection services, and has a system comprising computer systems 5 and databases 6 which are interconnected by a LAN (or WAN) 7. The system configuration of the ISP 2 is not limited to the illustrated one, and the ISP system may be constituted by a single main frame computer. Further, the databases 6 need not always be installed in the system of the ISP 2, and may be those located in a different system and referenced via the Internet. In the latter case, the databases can be identified using a URL (Uniform Resource Locator), an IP (Internet Protocol) address or the like.

Each of the users 3 has a small terminal system, such as a personal computer, and the terminal of each user 3 is connected to the ISP 2 via, for example, a public telephone network to receive the Internet connection service from the ISP 2. A Point-to-point protocol (PPP), for example, is used for a connection to the ISP 2. The user 3 may receive a mail service and/or HTTP connection service under the control of the ISP 2.

Each of the companies 4 is connected to the Internet 1. Any connection form may be employed, for example, an IP address may be obtained to run the company's system as an Internet server, or the system may be connected to the Internet 1 via the ISP 2. The company 4 is a business entity that utilizes the Internet to develop business activities such as advertising and electronic commerce activities, and that desires, as the premise of the activities, to obtain personal information of Internet users who will be customers of the company.

The personal information of each user who uses the ISP 2 is stored in the database 6. The personal information includes user information such as a user name and an address, usage history of the user, taste information and information required for online shopping. As will be described later, such information is to be traded with the companies 4, or can be referenced as input data when the user does online shopping via the ISP 2.

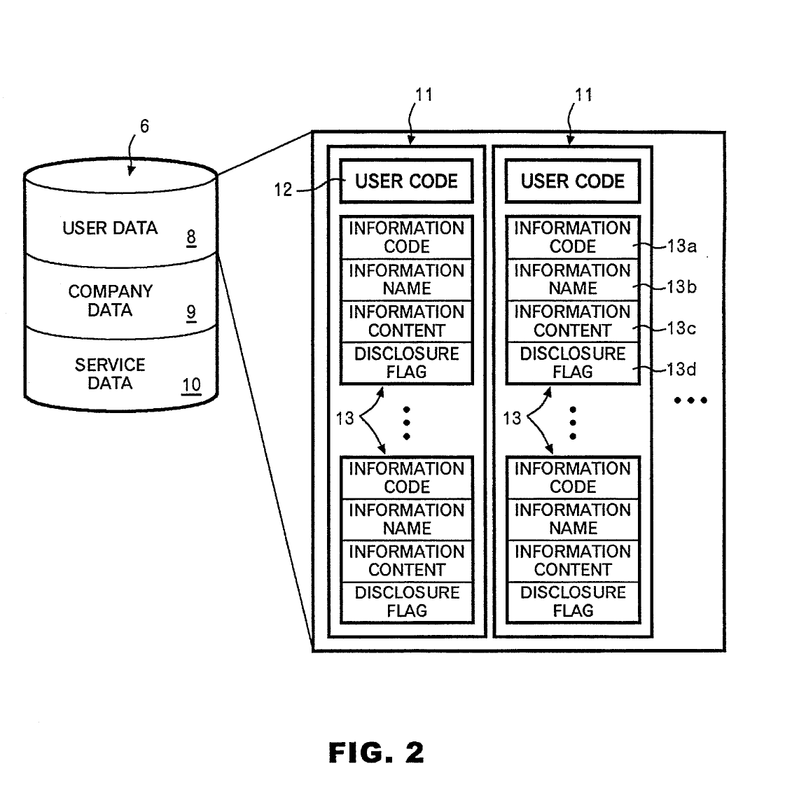

FIG. 2 shows an illustrative data structure for the information stored in the database 6. User data 8, company data 9 and service data 10 are stored in the database 6.

In the user data 8, a personal information entry 11 is recorded for each user 3 of the ISP 2. Included in each personal information entry 11 are a user code 12 for a user 3, and information items 13. The information items 13 include, for example, an information code 13 a, an information name 13b, an information content 13c and a disclosure flag 13d. The information code 13a is a code used to identify the information item 13 and consists of arbitrary alphanumeric characters. The information name 13b is a title of the information entry 13, which may be, for example, “user name”, “user address”, “user's e-mail address”, “user's ISP usage history”, or “user's taste information”. The information content 13c includes the one corresponding to the information item 13b. For example, if the information item 13 is a user name, then a user name such as “Taro Yamato” is stored in the information content 13c. The disclosure flag 13d indicates whether the content (information content 13c) of the information item 13 is public or secret. The flag 13d is set to “1” if the content is public or disclosable, and set to “0” if the content is secret. As will be described later, the disclosure flag 13d is specified by a user when the user registers his/her personal information. Since the disclosure flag 13d represents the intention of the user, it is never changed by the ISP 2. However, the disclosure flag 13d may not be a fixed entry, and may be changed by a genuine user periodically, e.g., monthly.

In the company data 9, information on a company which purchases personal information is stored. It is premised that any company which receives personal information will handle it appropriately. Therefore, the ISP 2 examines a company's eligibility to receive data as will be described later. In the company data 9, data required for such an examination and data required for the management of a registered company are recorded.

In the service data 10, data used by the ISP 2 are stored, which include a system program required for the operation of the system of the ISP 2.

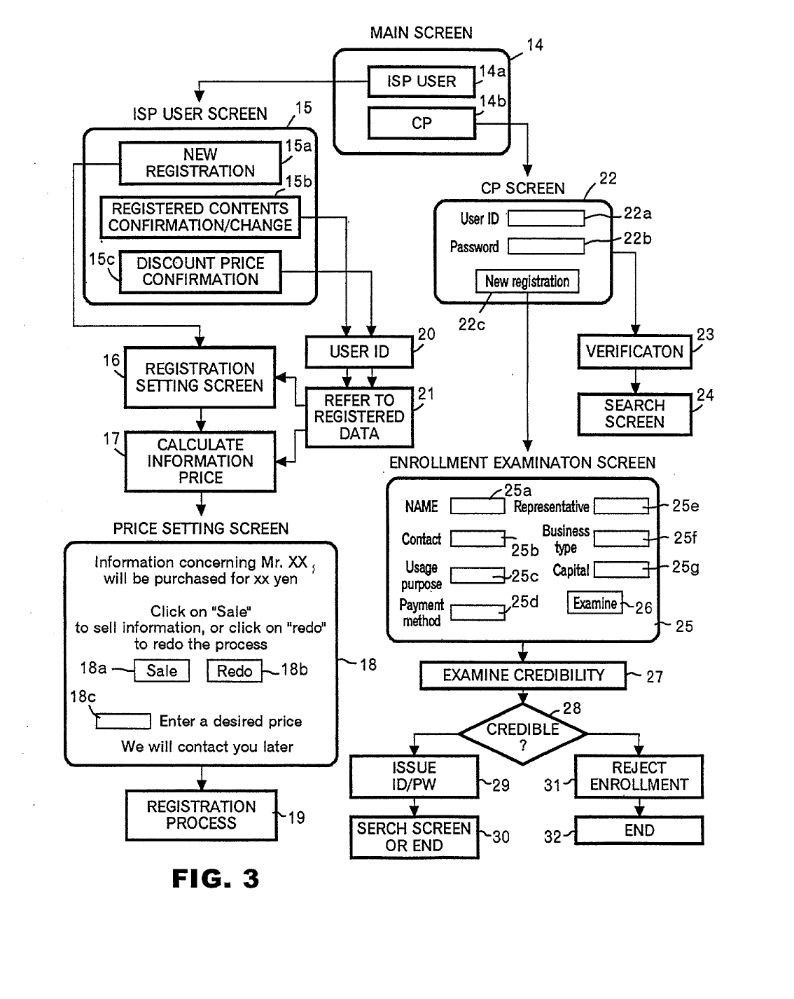

The method for trading in personal information according to the preferred embodiment will now be described. FIG. 3 is a flowchart showing an illustrative trading method according to the embodiment.

First, a main screen is displayed on the display device of the computer system of the user 3 or the company 4 (step 14). To display the main screen, for example, upon receipt of an HTTP request from the computer system (client) of the user 3 or the company 4, the system (server) of the ISP 2 responds by forwarding an HTML or XML document to the client computer system which then displays the received document. Succeeding screens may also be displayed in a similar manner.

A button 14a for an ISP user and a button 14b for a company (CP) are displayed on the main screen. A user 3 will select the user button 14a while a company 4 will select the CP button 14b. This selection may be done by, for example, moving a pointer onto a corresponding button with a mouse and clicking a mouse button. The same process will be employed whenever a button or other item is selected on the screen.

If the ISP user button 14a is selected, an ISP user screen is displayed (step 15). On the ISP user screen, a new registration button 15a, a registered contents confirmation/change button 15b, and a discount price confirmation button 15c are displayed. The new registration button 15a is a button for an ISP user who has not yet been registered to provide personal information. By selecting the button 15a, the user can proceed to a registration process (making a contract with the ISP) for the provision of personal information. The registered contents confirmation/change button 15b is used by a user 3 who has previously made a contract with the ISP to provide personal information. By selecting the button 15b, the user can confirm and change registered contents. The discount price confirmation button 15c is also used by a user who has made a contract with the ISP to provide personal information. By selecting the button 15c, the user can confirm a discount price that is set in compensation for providing the personal information, and renegotiate with the ISP about the price (discount price).

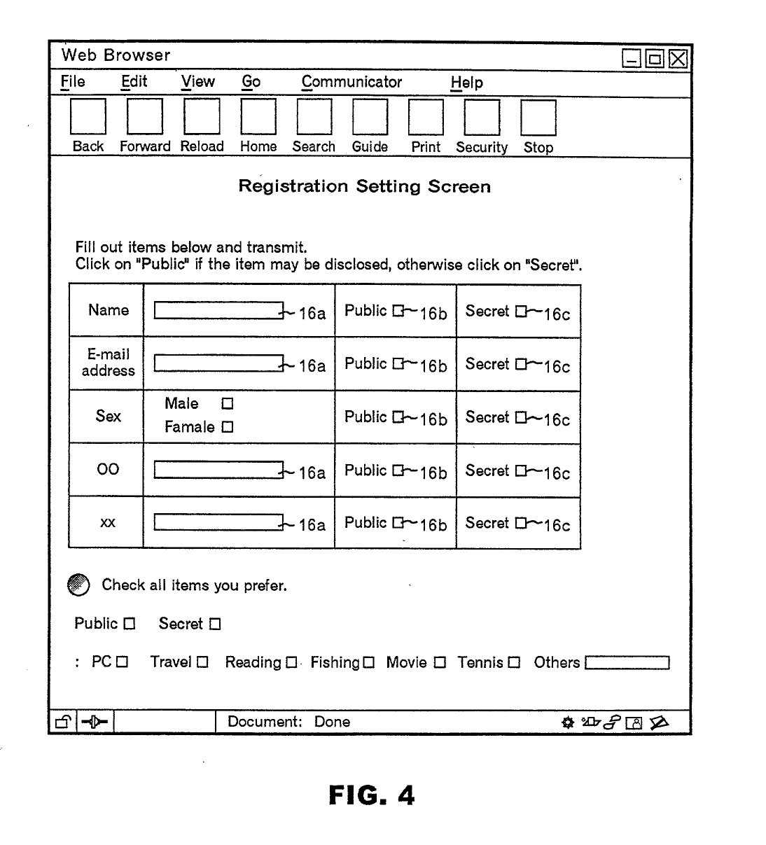

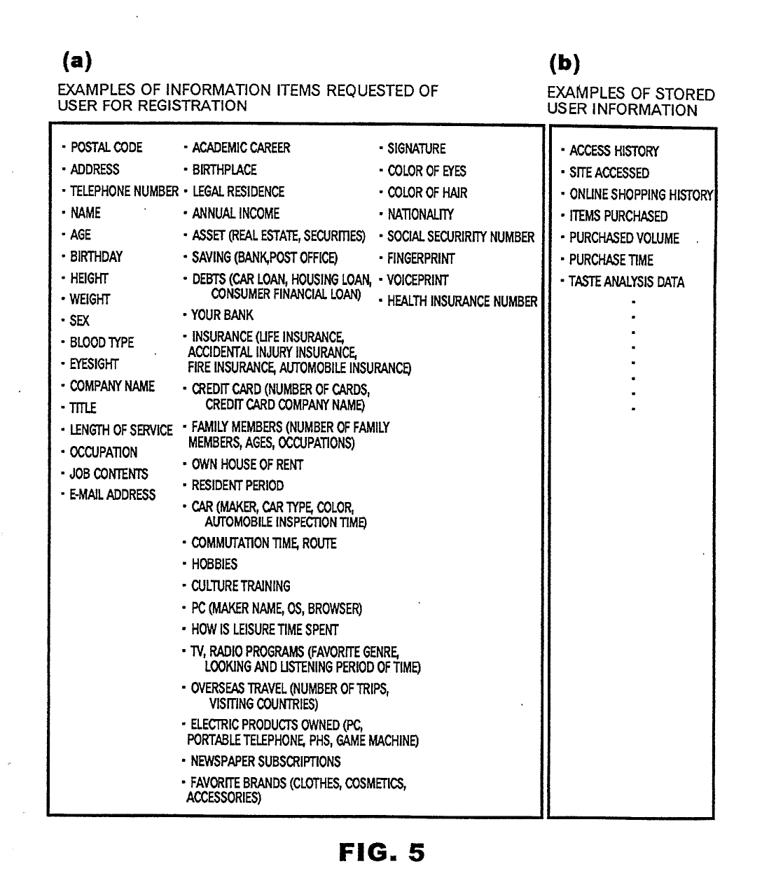

If the new registration button 15a is selected, the ISP user screen is changed to a new registration screen (step 16). FIG. 4 shows an illustrative registration setting screen. On the registration setting screen in FIG. 4, an input field 16a and check boxes 16b and 16c are provided for each item. The user enters in the input field 16a an information content corresponding thereto. For example, “Hanako Tokkyo” may be entered in the input field 16a on a row of the item “name”. The illustrative items on this screen are “name”, “e-mail address” and “sex”, but the items should not be limited thereto. Possible information items used in the registration process are shown in FIG. 5(a), which are obtained when a user 3 enters their contents. Additional information items other than those entered by the user are shown in FIG. 5(b), which are collected by the ISP 2. Although the contents of the data shown in FIG. 5(b) are not available to the user at the time of user's registration, the user can determine on the registration screen whether or not these information items may be disclosed. The data collected by the ISP 2 may include data analyzed by using, for example, a knowledge management technique. Although such knowledge data obtained by the knowledge management may include data different from or inconsistent with those entered by the user, the knowledge management is advantageous in that data such as user's taste can be obtained which are useful for sales promotion and, therefore, desired by many companies. Such knowledge data could also be traded if the user permits it.

In the present embodiment, the check boxes 16b and 16c are used to indicate for each information item whether its title and content may be disclosed (public) or must not be disclosed (secret). Thus, the user can control his/her personal information according to the user's intention. Since the selection of public or secret can be made for each item of the personal information in the present embodiment, the present invention meets various needs of users, for example, user's name may be disclosed while hobbies must not be disclosed. As will be described later, if an information item which is more valuable to one or more companies is specified as public or disclosable, the item is rated high and will be offered to such companies with a higher price. Although data are entered by means of the data fields and check boxes on the above registration setting screen, they may be entered in any other way such as selection from a list or selection by a combo box.

Returning to FIG. 3, the value of the information is next evaluated based on the registered contents (step 17). The evaluation is done for the items which have been specified as public, by weighting each of the items by a coefficient depending on the information value of the item and summing the weighted values of these items. For the items which have been specified as secret, the coefficient is zero because such items are never disclosed.

The calculated information price is then presented to the user on a price setting screen in step 18 using a form such as “Information concerning Mr. XX will be purchased for xx yen”. If the user agrees to the presented price, the user clicks on a sale button 18a. Otherwise the user clicks on a redo button 18b to terminate the process. Alternatively, if the user does not agree to the presented price but desires to negotiate with the ISP, the user may enter a desired price in the input field 18c. Once the desired price is entered, the ISP will later get in contact with the user for the price negotiation. Naturally, electronic mail may be used for such a negotiation.

If the user and the ISP reach an agreement on the price, the information entered on the registration setting screen is registered (step 19). The registration process is performed by recording the entered personal information in the user data area 8 of the database 6 in the above described format.

If the registered contents confirmation/change button 15b or the discount price confirmation button 15c is selected on the ISP user screen (step 15), the user ID is examined (step 20) and the database 6 is searched to refer to registered data of a user having that ID (step 21). In the case of the registered contents confirmation/change, the ISP user screen is changed to the registration setting screen and the registered data referred to are displayed as target data in the input fields 16a of the registration setting screen. Since the contents of the registered data are displayed in the input fields 16a as the target data, the user can easily confirm the registered contents, which is convenient to modify the registered contents. Alternatively, the contents of the registered data may be displayed in a list form for the confirmation instead of using the registration setting screen. In the case of the discount price confirmation, the process proceeds to step 17 for the calculation of the price after referring to the registered data (step 21). The succeeding steps are performed in the above described manner.

As described above, the personal information of a user is recorded (registered) with each item thereof being specified as either public or secret by the user. Therefore, the user can be concerned with the disclosure of his/her personal information even after the user has provided the personal information to the ISP. In addition, the user can obtain monetary profit corresponding to the agreed price in compensation for the disclosure. The profit may be obtained as a discount for the ISP usage charge. Furthermore, the personal information that is the subject of trading with a company may also be used as reference data for entering information requested on a web page of a company when the user browses the web page via the ISP, as will be described below. Therefore, the user may not enter the personal information one by one each time its input is requested during web page browsing, which is convenient for the user. An expiration time may be set for the registered data. For example, a period during which the ISP can provide the information to the companies is set to one month. After the period has expired, trading in the information is inhibited. In this case, a means may be provided for advising the user to extend the period by, for example, e-mail from the ISP before the expiration of the period.

An explanation will now be given for the processing performed when the CP button 14b is selected on the main screen (step 14). When the CP button 14b is selected, a CP screen is displayed on the display device of the company's computer system (step 22). On the CP screen, a user ID and password of the company which were issued in advance by the ISP are requested, and a company's operator enters the requested data in input fields 22a and 22b. This step is necessary to verify that the company is a legitimate user because the company is expected to utilize the personal information properly. The ISP performs the verification using the entered user ID and password. If the verification is successful, a search screen is displayed (step 24). The search screen will be described later. If the verification fails, a failure message is displayed on the screen and the process is terminated.

When the company uses this system for the first time, i.e., a user ID and password have not yet been issued, the company's operator selects a new registration button 22c. Once the new registration button 22c is selected, an enrollment examination screen is displayed (step 25).

The enrollment examination screen includes input fields 25a to 25g for entering data required for the enrollment examination. The input data shown on enrollment examination screen are for illustrative purpose only, and other input data may be requested. For example, a company name is entered in the input field 25a, and contact information is entered in the input field 25b. Additionally, usage purpose, payment method, representative, type of business and capital are entered. After these data have been entered, an examination button 26 is clicked on.

The data entered in the input fields 25a to 25b are then transmitted to the ISP where the credibility of the company that has submitted the registration data is examined (step 27). Any company that is not expected to handle the personal information properly is not allowed to use this system. It is determined whether the company is credible based on the result of the credibility examination (step 28), and if credible, the ISP issues a user ID and a password (step 29). Thereafter, the search screen is displayed, or the process is terminated (step 30). However, if the company is found to be inappropriate to use this system, e.g., abusing the personal information, after the user ID and password have been issued, the registration would be canceled (the user ID would be invalidated).

If it is determined in step 28 that the credibility of the company is not satisfactory, a message indicating that the enrollment has been rejected is displayed (step 31), and the process is terminated (step 32). Thus, the proper handling (trading) of the personal information that should be handled with care is assured by such examination before registration. In addition, so long as the ISP properly manages the company to which personal information is provided, the user can provide his/her personal information without anxiety. Thus, it is expected that many users will provide their personal information, and this can contribute to the growth of a fairly administered market for trading in personal information.

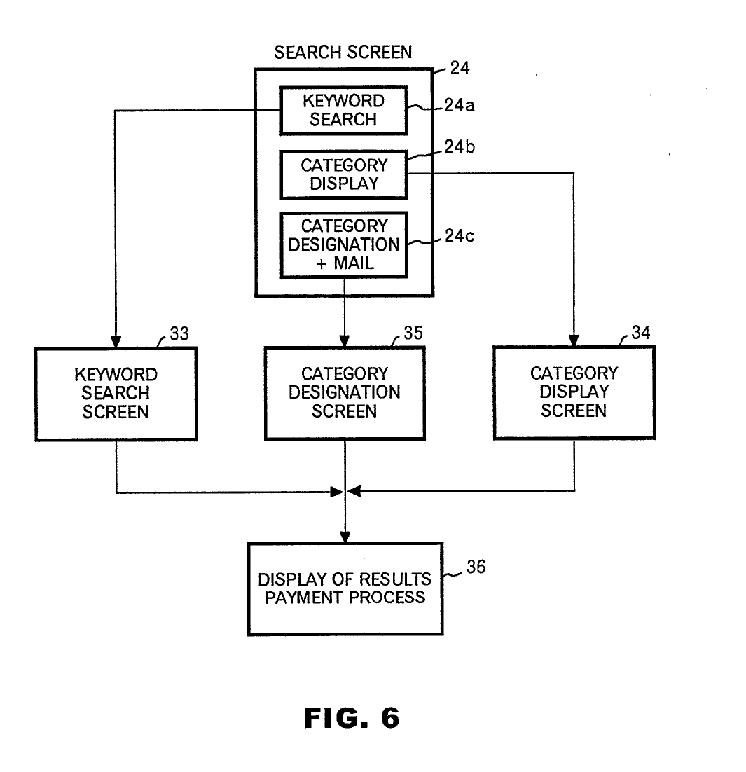

FIG. 6 is a flowchart showing an illustrative search operation performed by a company. A search screen 24 includes various buttons for selecting a search type, such as a keyword search button 24a, a category display button 24b, and a button 24c for requesting mail delivery after a category or categories have been designated (step 24).

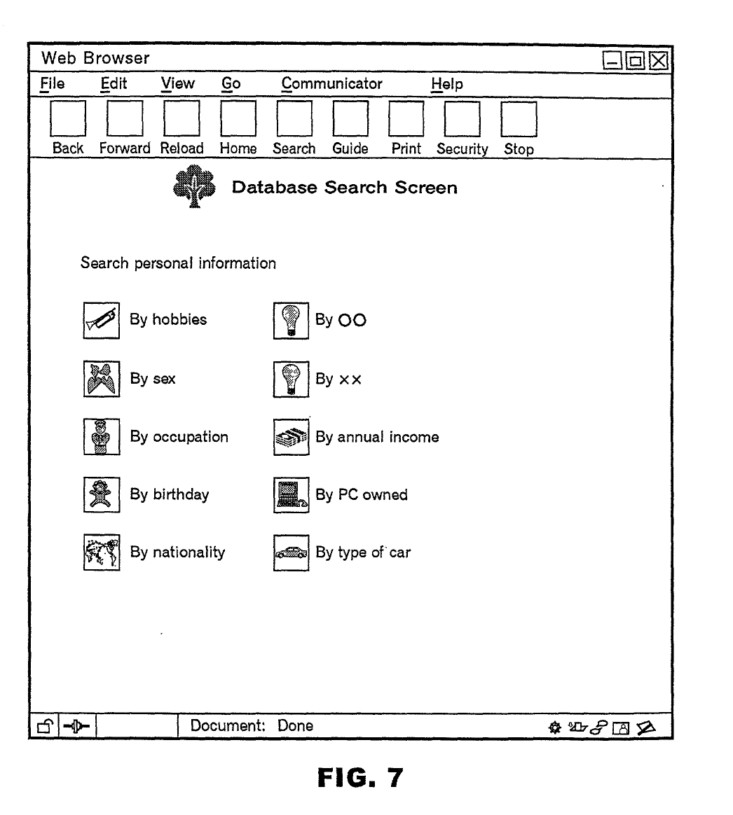

If the keyword search button 24a is selected, a keyword search screen is displayed (step 33). For a keyword search, a keyword, such as “computer”, “real estate”, “purchase of a new car” or “resident of Yamato-shi”, is input, and a search is performed for personal information that includes the input keyword. Of course, a search using logical operators such as AND, OR, etc. may also be performed. If the category display button 24b is selected, a category display screen is displayed (step 34). FIG. 7 shows an illustrative display screen. Predetermined search categories, such as hobbies, sex, occupation, annual income, birthday, type of personal computer owned, nationality, type of car owned, are displayed on the category display screen. These categories are selected, and a class for each category (e.g., female, male, or both for sex) is selected. Of course, other categories may also be presented.

When a search or selection operation has been performed in the above described manner, a set of users is assembled whose personal information matches the conditions established for the search, and the personal information included in this set is provided to the company. The requested personal information may be provided by displaying the results of the search or selection process (step 36), or downloading the personal information to the company. After the personal information has been provided, a payment process is performed (step 36).

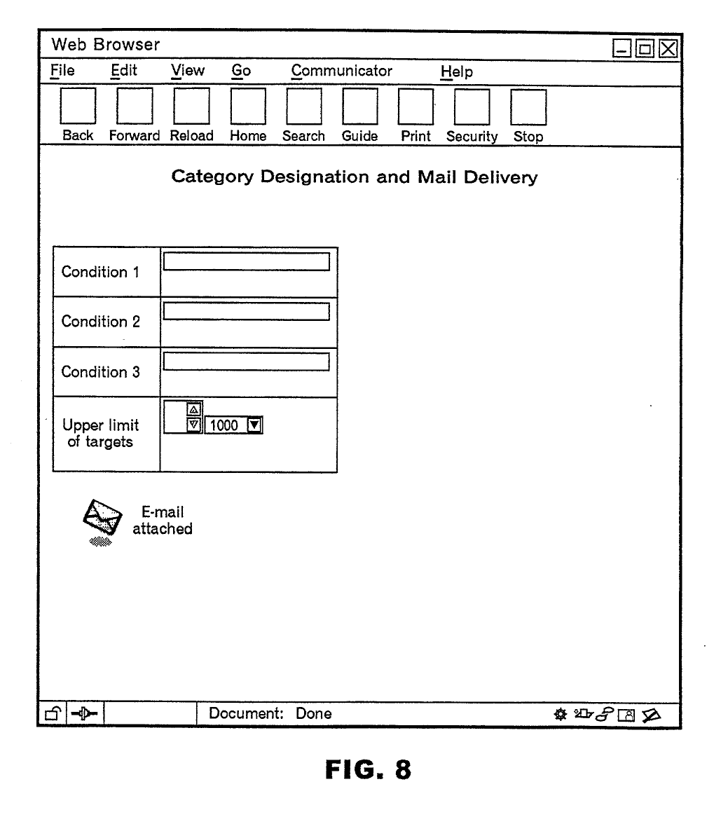

If the button 24c is selected, a category designation screen is displayed (step 35). FIG. 8 shows an illustrative category designation screen. As shown in FIG. 8, one or more conditions are input to search the database. In this example, search results are not displayed, and e-mail is delivered to users matched in the search. The e-mail is delivered by the ISP, and a report is mailed to the company from the ISP to notify the delivery results. In this case, the e-mail report may include only the number of e-mails delivered with the e-mail addresses of destinations being masked to maintain the secrecy of the personal information. In the present embodiment, the upper limit may be placed on the number of matching data (targets), and the e-mail may be delivered up to this upper limit. If the number of targets exceeds the upper limit, the ISP may select destinations of the e-mail at random, or may reduce the number of targets by inputting one or more other conditions. However, if the number of targets does not reach the upper limit, the e-mail is delivered to the proprietors of the personal information that matches the search conditions.

In this manner, the utilization of personal information by companies is facilitated. When personal information is utilized by a company, the company is charged depending on the amount of utilization. The charge is paid to the ISP according to the predetermined payment method, and the ISP applies the paid money to discount the ISP usage charges for the users whose personal information was utilized by the company. The above search method is merely an example, and other search methods may also be employed.

According to the system and method for trading in personal information in the above embodiments, each of the users 3 can sell his/her personal information under the control thereof, and can obtain a profit, such as a discount in an ISP usage charge, in compensation for the sale. On the other hand, the companies 4 can easily acquire reliable personal information, and the ISP 2 can collect an information offering charge from the companies, and can thus afford to set lower connection service charges in order to acquire more users. Since the acquisition of more users increases the opportunities for the collection of personal information, the resultant system is also attractive to the companies. Thus, a trading system can be provided that furnishes large benefits to all three parties involved.

Although the present invention has been described with reference to the preferred embodiments thereof, the present invention is not limited to the above embodiments, and can be variously modified without departing from the scope and spirit of the invention.

What is claimed is:

1. For use by an Internet service provider, a method of processing personal information provided by a user receiving Internet connection service, said method comprising the steps of:
identifying items of personal information provided by the user as being either public or secret;
storing the personal information in a database in records which include the identification of each item as being public or secret;
in response to a request from a business entity connected to the Internet, retrieving and utilizing those items of stored personal information identified as public.

2. The method as set forth in claim 1 further including the steps of:
offering compensation to the user if the user agrees to allow at least some of the personal information to be retrieved and utilized; and
completing the storing step only if the user has so agreed.

3. The method as set forth in claim 2 including the further step of providing compensation based on the number of times the information is retrieved and utilized.

4. The method as set forth in claim 1 further including the steps of:
in response to a request from a business entity, generating a search screen having fields related to the items stored in records in the database;
accepting search terms entered through the use of the search screen;
identifying personal information stored in the database that satisfies conditions established by the accepted search terms; and
retrieving and utilizing the identified personal information for the benefit of the requesting business entity.

5. The method as set forth in claim 4 further including the steps of:
receiving information from the requesting business entity; and
delivering the received information to the users who owned personal information retrieved and utilized for the benefit of the requesting business entity.

6. The method as set forth in claim 5 further including the step of informing the requesting business entity of the delivery of the received information.

7. The method as set forth in claim 1 wherein the personal information includes but is not limited to the number of times the user has accessed the Internet through the service provider and a history of purchases made by the user.

8. The method as set forth in claim 7 wherein said personal information includes the service provider's assessments of the user's purchasing patterns.

9. An Internet service provider system for processing personal information provided by a user receiving Internet connection service, said system including:
logic for cause items of personal information provided by the user to be classified either as public or secret;
a memory subsystem for storing the personal information in a database in records which include the classification of each item as being public or secret;
a search subsystem responsive to a request from a business entity connected to the Internet to identify items of stored personal information previously classified as public; and
a data subsystem for retrieving identified items of stored personal information to be used for the benefit of a requesting business entity.

10. A system as defined in claim 9 further including:
a logic subsystem for assigning values to items of personal information which may be used for the benefit of requesting business entity; and
a compensation subsystem for using the assigned values to determining an amount of compensation to be made available to the user when the user's personal information is retrieved for use for the benefit of the requesting business entity.

11. A system as defined in claim 9 further including:
a search subsystem including a display capable of generating a search screen having fields related to the items stored in records in the database and a query subsystem for accepted search terms entered through the use of the search screen;
an input system accepting search terms entered through the use of the search screen;
logic for identifying personal information stored in the database that satisfies conditions established by the accepted search terms; and
a data system for retrieving and utilizing the identified personal information for the benefit of the requesting business entity.

12. The system as defined in claim 11 further including a mail subsystem for receiving information from the requesting business entity and delivering the received information to the users who owned personal information retrieved and utilized for the benefit of the requesting business entity.

13. The system as defined in claim 9 further including a user storage subsystem for generating and storing information which includes but is not limited to the number of times the user has accessed the Internet through the service provider and a history of purchases made by the user.

14. The system as defined in claim 13 wherein said personal information includes the service provider's assessments of the user's purchasing patterns.

15. A computer-readable storage medium for storing a program for executing the computer-implemented steps of:
receiving personal information provided by a user receiving Internet connection service;
identifying items of personal information provided by the user as being either public or secret;
storing the personal information in a database in records which include the identification of each item as being public or secret;
in response to a request from a business entity connected to the Internet, retrieving and utilizing those items of stored personal information identified as public.
